(19) United States
(12) Patent Application Publication
(10) Pub. No.: US 2023/0387453 A1
(43) Pub. Date: Nov. 30, 2023

(54) SOLID-STATE ELECTROLYTE MATERIALS FOR ALL-SOLID-STATE BATTERIES

(71) Applicant: GM GLOBAL TECHNOLOGY OPERATIONS LLC, Detroit, MI (US)

(72) Inventors: Thomas A. YERSAK, Royal Oak, MI (US); Hernando Jesus GONZALEZ MALABET, Farmington Hills, MI (US); Yubin ZHANG, Madison Heights, MI (US)

(73) Assignee: GM GLOBAL TECHNOLOGY OPERATIONS LLC, Detroit, MI (US)

(21) Appl. No.: 17/824,584

(22) Filed: May 25, 2022

(51) Int. Cl. H01M 10/0562; H01M 4/38; H01M 4/505; H01M 4/525; H01M 4/485; H01M 10/0525

(52) U.S. Cl. CPC H01M 10/0562; H01M 4/382; H01M 4/505; H01M 4/525; H01M 4/485; H01M 10/0525; H01M 2300/008; H01M 2004/027

(57) ABSTRACT

The present disclosure provides an all-solid-state electrochemical battery that includes a positive electrode, a negative electrode, and a solid-state electrolyte layer disposed between and separating the positive electrode and the negative electrode. The positive electrode includes a positive electroactive material and a solid-state electrolyte material. The solid-state electrolyte material may be represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof. In certain variations, the positive electroactive material includes a nickel-rich electroactive material, and the solid state electrolyte layer includes a sulfide-based electrolyte material. The solid-state electrolyte layer can also include the solid-state electrolyte material may be represented by Li₃AB₆.

### GOVERNMENT FUNDING

This invention was made with government support under Agreement No. DE-EE0008857 awarded by the Department of Energy. The Government may have certain rights in this invention.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. In various aspects, positive electrodes include nickel-rich electroactive materials (e.g., greater than or equal to about 0.6 mole fraction on transition metal lattice), such as NMC (LiNi_{1-x-y} CoₓMn_{y}O₂) (where 0.10≤x≤0.33, 0.10≤y≤0.33) or NCMA (LiNi_{1-x-y-z} CoₓMn_{y}Al_{z}O₂) (where 0.02≤x≤0.20, 0.01≤y≤0.12, 0.01≤z≤0.08), which are capable of providing improved capacity capability (e.g., greater than 200 mAh/g) while allowing for additional lithium extraction without compromising the structural stability of the positive electrode. Such materials, however, often have poor interfacial compatibility or stability with solid-state electrolytes, and in particular, sulfide electrolyte. Hot pressing processes can be used during the formation of solid-state electrolyte layers, and also, solid-state electrodes. However, solid-state electrolytes, and in particular, sulfide electrolyte, often negatively react with nickel-rich electroactive materials at elevated temperatures. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to all-solid-state electrochemical cells having reduced porosity and including solid-state electrolyte materials represented by Li₃AB₆, where A is yttrium (Y), indium (In), scandium (Sc), or erbium (Er), and B is chloride (Cl), bromide (Br), and/or ClₓBr₍ₓ₋₁₎, where 0<x<1, as well as methods of making and using the same.

In various aspects, the present disclosure provides an all-solid-state electrochemical battery that includes a positive electrode, a negative electrode, and a solid-state electrolyte layer disposed between and separating the positive electrode and the negative electrode. The positive electrode includes a positive electroactive material and a solid-state electrolyte material. The solid-state electrolyte material may be represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof. The negative electrode may include a negative electroactive material.

In one aspect, the positive electrode may have a porosity less than or equal to about 15 vol. %.

In one aspect, the positive electroactive material may be selected from the group consisting of: NMC (LiNi_{1-x-y}CoₓMn_{y}O₂) (where 0.10≤x≤0.33, 0.10≤y≤0.33), NCMA (LiNi_{1-x-y-z}CoₓMn_{y}Al_{z}O₂) (where 0.02≤x≤0.20, 0.01≤y≤0.12, 0.01≤z≤0.08), and combinations thereof.

In one aspect, the solid-state electrolyte layer may include a solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

In one aspect, the positive electrode may have a positive electroactive material loading greater than or equal to about 70 wt. %,

In one aspect, the solid-state electrolyte layer may have a porosity less than or equal to about 15 vol. %, and the solid-state electrolyte layer may also include the solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof.

In one aspect, the solid-state electrolyte layer may further include a second solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

In one aspect, the negative electrode may include a lithium metal foil.

In one aspect, the negative electrode may include a negative electroactive material selected from the group consisting of: lithium, silicon, silicon oxide, graphite, Li₄₊ₓTi₅O₁₂ (where 0≤x≤3), and combinations thereof.

In various aspects, the present disclosure may provide an all-solid-state electrochemical battery that includes a positive electrode, a negative electrode, and a solid-state electrolyte layer disposed between and separating the positive electrode and the negative electrode. The positive electrode may include a positive electroactive material. The negative electrode may include a negative electroactive material. The solid-state electrolyte layer may include a solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof.

In one aspect, the solid-state electrolyte layer may have a porosity less than or equal to about 15 vol. %.

In one aspect, the positive electroactive material may be selected from the group consisting of: NMC (LiNi_{1-x-y}CoₓMn_{y}O₂) (where 0.10≤x≤0.33, 0.10≤y≤0.33), NCMA (LiNi_{1-x-y-z}CoₓMn_{y}Al_{z}O₂) (where 0.02≤x≤0.20, 0.01≤y≤0.12, 0.01≤z≤0.08), and combinations thereof.

In one aspect, the positive electrode may also include the solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof.

In one aspect, the solid-state electrolyte material may be a first solid-state electrolyte material and the solid-state electrolyte layer may further include a second solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

In one aspect, the positive electrode may have a porosity less than or equal to about 15 vol. %.

In various aspects, the present disclosure may provide a method for preparing an all-solid-state battery. The method may include preparing a positive electrode having a porosity less than or equal to about 15 vol. % and a positive solid-state electroactive material loading greater than or equal to about 70 wt. % by contacting a plurality of positive solid-state electroactive particles and a plurality of solid-state electrolyte particles to form an admixture, and applying a pressure to the admixture at a temperature greater than or equal to about 200° C. to less than or equal to about 250° C. for a period greater than or equal to about 0.1 minutes to less than or equal to about 10 minutes to form the positive electrode. The solid-state electrolyte particles may include a solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof. The pressure may be greater than or equal to about 75 MPa to less than or equal to about 450 MPa.

In one aspect, the plurality of solid-state electrolyte particles may be a first plurality of solid-state electrolyte particle, the pressure is a first pressure, the temperature is a first temperature, the period is a first period, and the method may further include preparing a solid-state electrolyte layer. Preparing the solid-state electrolyte layer may include applying a second pressure to a second plurality of solid-state electrolyte particles at a second temperature greater than or equal to about 200° C. to less than or equal to about 250° C. for a second period greater than or equal to about 0.1 minute to less than or equal to about 10 minutes to form the solid-state electrolyte layer. The second pressure may be greater than or equal to about 75 MPa to less than or equal to about 450 MPa. The preparing of the solid-state electrolyte layer may occur concurrently or consecutively with the preparing of the positive electrode.

In one aspect, the solid-state electrolyte layer may be prepared concurrently with the positive electrode, and the method may further include disposing the second plurality of solid-state electrolyte particles adjacent to the admixture.

In one aspect, the method may further include disposing a lithium metal foil on or adjacent to an exposed surface of the solid-state electrolyte layer.

In one aspect, the admixture may be a first admixture and the method may further include disposing a second admixture on or adjacent to an exposed surface defined by the second plurality of solid-state electrolyte particles. The second admixture may include a plurality of negative solid-state electroactive particles and a third plurality of solid-state electrolyte particle.

In one aspect, the second plurality of solid-state electrolyte particles may be the same as the first plurality of solid-state electrolyte particles.

In one aspect, the solid-state electrolyte material may be a first solid-state electrolyte material and the second plurality of solid-state electrolyte particles may include a second solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example all-solid-state electrochemical cell in accordance with various aspects of the present disclosure;

FIG. 2A is a scanning electron microscopy image of an example solid-state electrolyte layer prepared using a hot press process in accordance with various aspects of the present disclosure;

FIG. 2B is a scanning electron microscopy image of a comparative solids-state electrolyte layer prepared using a cold press process;

FIG. 3A is a scanning electron microscopy image of a positive electrode prepared using a hot press process in accordance with various aspects of the present disclosure;

FIG. 3B is a scanning electron microscopy image of a positive electrode prepared using a cold press process;

FIG. 4A is a graphical illustration demonstration the first cycle voltage profiles of an example battery prepared in accordance with various aspects of the present disclosure; and

FIG. 4B is a graphical illustration demonstration the normalized cyclic capacity of an example battery prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawing.

The present technology relates to all-solid-state electrochemical cells having reduced porosity and including solid-state electrolyte materials represented by Li₃AB₆, where A is yttrium (Y), indium (In), scandium (Sc), or erbium (Er), and B is chloride (Cl), bromide (Br), and/or ClₓBr₍ₓ₋₁₎, where 0<x<1, as well as methods of making and using the same. Such cells may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

In certain variations, batteries including all-solid-state electrochemical cells that are prepared in accordance with various aspects of the present disclosure may have a bipolar stacking design comprising a plurality of bipolar electrodes where a first mixture of electroactive material particles (and optional solid-state electrolyte particles) is disposed on a first side of a current collector, and a second mixture of electroactive material particles (and optional solid-state electrolyte particles) is disposed on a second side of a current collector that is parallel with the first side. The first mixture may include, as the electroactive material particles, cathode material particles having one or more coatings. The second mixture may include, as the electroactive material particles, anode material particles. The solid-state electrolyte particles in each instance may be the same or different.

In other variations, batteries including all-solid-state electrochemical cells that are prepared in accordance with various aspects of the present disclosure may have a monopolar stacking design comprising a plurality of monopolar electrodes where a first mixture of electroactive material particles (and optional solid-state electrolyte particles) is disposed on both a first side and a second side of a first current collector, wherein the first and second sides of the first current collector are substantially parallel, and a second mixture of electroactive material particles (and optional solid-state electrolyte particles) is disposed on both a first side and a second side of a second current collector, where the first and second sides of the second current collector are substantially parallel. The first mixture may include, as the electroactive material particles, cathode material particles having one or more coating. The second mixture may include, as electroactive material particles, anode material particles. The solid-state electrolyte particles in each instance may be the same or different. In certain variations, the batteries may include a mixture of combination of bipolar and monopolar stacking designs.

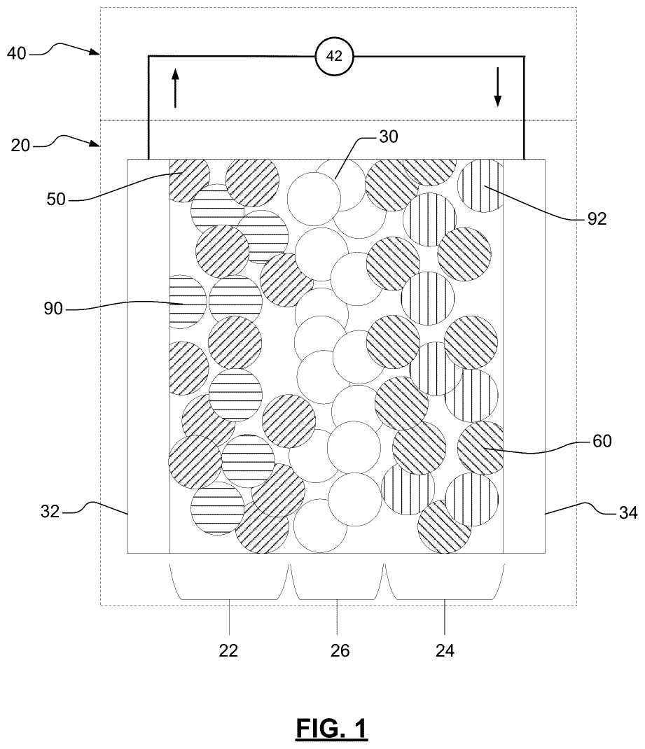

An exemplary and schematic illustration of a solid-state electrochemical cell (also referred to as a “all-solid-state battery” and/or “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the electrodes. The electrolyte layer 26 is a solid-state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network. The second plurality of solid-state electrolyte particles 90 may define an anolyte. The third plurality of solid-state electrolyte particles 92 may define a catholyte.

A first current collector 32 may be positioned at or near the negative electrode 22. In certain instances, the first current collector 32 together with the negative electrode 22 may be referred to as a negative electrode assembly. The first current collector 32 may be a metal foil, metal grid or screen, or expanded metal comprising copper, stainless steel, nickel, iron, titanium, or any other appropriate electrically conductive material known to those of skill in the art. In certain variations, the first current collector 32 may be coated foil having improved corrosion resistance, such as graphene or carbon coated stainless steel foil. The first current collector 32 may have an average thickness greater than or equal to about or exactly 2 μm to less than or equal to about or exactly 30 μm.

A second current collector 34 may be positioned at or near the positive electrode 24. In certain instances, the second current collector 34 together with the positive electrode 24 may be referred to as a positive electrode assembly. The second current collector 34 may be a metal foil, metal grid or screen, or expanded metal comprising stainless steel, aluminum, nickel, iron, titanium, or any other appropriate electrically conductive material known to those of skill in the art. In certain variations, the second current collector 34 may be coated foil having improved corrosion resistance, such as graphene or carbon coated stainless steel foil. The second current collector 34 may have an average thickness greater than or equal to about or exactly 2 μm to less than or equal to about or exactly 30 μm.

Although not illustrated, the skilled artisan will recognize that in certain variations, the first current collector 32 may be a first bipolar current collector and/or the second current collector 34 may be a second bipolar current collector. For example, the first bipolar current collector 32 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 32 includes another metal (e.g., second metal). The cladded foil may include, for example only, aluminum-copper (Al—Cu), nickel-copper (Ni—Cu), stainless steel-copper (SS—Cu), aluminum-nickel (Al—Ni), aluminum-stainless steel (Al—SS), or nickel-stainless steel (Ni—SS). In certain variations, the first bipolar current collector 32 and/or second bipolar current collectors 34 may be pre-coated, such as graphene or carbon-coated aluminum current collectors.

The first current collector 32 and the second current collector 34 may be the same or different. In each instance, however, the first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular application for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, as introduced above, the electrolyte layer 26 provides electrical separation—preventing physical contact—between the negative electrode 22 and the positive electrode 24. The electrolyte layer 26 also provides a minimal resistance path for internal passage of ions. In various aspects, the electrolyte layer 26 may be defined by a first plurality of solid-state electrolyte particles 30. For example, the electrolyte layer 26 may be in the form of a layer or a composite that comprises the first plurality of solid-state electrolyte particles 30. The solid-state electrolyte particles 30 may have an average particle diameter greater than or equal to about or exactly 0.02 μm to less than or equal to about or exactly 20 μm, optionally greater than or equal to about or exactly 0.1 μm to less than or equal to about or exactly 10 μm, and in certain aspects, optionally greater than or equal to about or exactly 0.1 μm to less than or equal to about or exactly 5 μm. For example, in certain variations, the solid-state electrolyte particles 30 may include sulfide-based particles. In other variations, the solid-state electrolyte particles 30 may include oxide-based solid-state particles, metal-doped or aliovalent-substituted oxide solid-state particles, nitride-based solid-state particles sulfide-based particles, hydride-based particles, halide-based particles, borate-based solid-state particles, and/or other solid-state electrolyte particles having a low grain-boundary resistance (e.g., less than or equal to about or exactly 20 ohms at about or exactly 25° C.).

The sulfide-based particles may include, for example only, pseudobinary sulfides, pseudoternary sulfides, and/or pseudoquaternary sulfides. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI·0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the sulfide-based particles may include oxysulfide-based electrolyte materials. The sulfide-based particles may include oxysulfide-based electrolyte materials may include lithium phosphorus (oxy)sulfide, sodium phosphorus (oxy)sulfide, lithium boron (oxy)sulfide, sodium boron (oxy)sulfide, lithium boron phosphorous oxysulfide, sodium boron phosphorous oxysulfide, lithium silicon (oxy)sulfide, sodium silicon (oxy)sulfide, lithium germanium (oxy)sulfide, sodium germanium (oxy)sulfide, lithium arsenic (oxy)sulfide, sodium arsenic (oxy)sulfide, lithium selenium (oxy)sulfide, sodium selenium (oxy)sulfide, lithium antimony (oxy)sulfide, and sodium antimony (oxy)sulfide. The term “(oxy)sulfide” refers to oxygen-free sulfide materials and oxygen-containing oxysulfide materials.

The oxide-based solid-state particles may include garnet type solid-state particles (e.g., Li₇La₃Zr₂O₁₂), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1). The metal-doped or aliovalent-substituted oxide solid-state particles may include aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1-Fx+y}AlₓTi₂₋ₓSi_{Y}P_{3-y}O₁₂ (where 0<x<2 and 0<y<3). The nitride-based solid-state particles may include Li₃N, Li₇PN₄, and/or LiSi₂N₃. The halide-based particles may include, for example only, Li₃YCl₆, Li₃InCl₆, Li₃YBr₆, LiI, Li₂CdCl₄, Li₂MgCl₄, LiCdI₄, Li₂ZnI₄, Li₃OCl, and combinations thereof. The hydride-based particles may include, for example only, LiBH₄, LiBH₄—LiX (where X═Cl, Br, or I), LiNH₂, Li₂NH, LiBH₄—LiNH₂, Li₃AlH₆, and combinations thereof. The boarate-based solid-state particles may include LI₂B₄O₇ and/or Li₂O—B₂O₃—P₂O₅.

In still other variations, the solid-state electrolyte particles 30 may include, like the positive electrode 24, one or more solid-state electrolyte materials represented by Li₃AB₆, where A is yttrium (Y), indium (In), scandium (Sc), or erbium (Er), and B is chloride (Cl), bromide (Br), and/or ClₓBr₍ₓ₋₁₎, where 0<x<1. In such instances, for example as further detailed below, the electrolyte layer 26 may be prepared using a hot press process, such that the electrolyte layer 26 has an interparticle porosity less than or equal to about 20 vol. %, optionally less than or equal to about 15 vol. %, optionally less than or equal to about 10 vol. %, and in certain aspects, optionally less than or equal to about 5 vol. %, and an average thickness greater than or equal to about 10 μm to less than or equal to about 500 μm, and in certain aspects, optionally greater than or equal to about 10 μm to less than or equal to about 100 μm, optionally greater than or equal to about 10 μm to less than or equal to about 50 μm.

Although not illustrated, it should be recognized that in each variation the solid-state electrolyte layer 26 may further include a filler and/or a polymeric binder. For example, the solid-state electrolyte layer 26 may include greater than or equal to about 80 wt. % to less than or equal to about 100 wt. %, and in certain aspects, optionally greater than or equal to about 90 wt. % to less than or equal to about 100 wt. %, of the solid-state electrolyte particles 30; greater than or equal to about 0 wt. % to less than or equal to about 20 wt. %, and in certain aspects, optionally greater than or equal to about 0 wt. % to less than or equal to about 10 wt. %, of the filler; and greater than or equal to about 0 wt. % to less than or equal to about 20 wt. %, and in certain aspects, optionally greater than or equal to about 0 wt. % to less than or equal to about 10 wt. %, of the polymeric binder.

Example fillers include oxide particles (e.g., SiO₂, Al₂O₃, TiO₂, ZrO₂), polymeric framework additives (e.g., polypropylene (PP), polyethylene (PE)), and/or lithium salts (e.g., lithium bis(trifluoromethanesulfonyl)imide (LiTFSI), lithium tetrafluoroborate (LiBF₄)). Example polymeric binders include polyimide, polyamic acid, polyamide, polysulfone, polyvinylidene difluoride (PVdF), poly(vinylidene fluoride-co-hexafluoropropylene) (PVdF-HFP), polytetrafluoroethylene (PTFE), polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), styrene butylene styrene copolymer (SEBS), sodium alginate, lithium alginate, poly(ethylene oxide) (PEO), polyvinylpyrrolidone (PVP), poly(vinyl alcohol), poly(acrylic acid) (PAA), and combinations thereof.

Further still, although not illustrated, it should be recognized that in each variation the solid-state electrolyte layer 26 may further include a reinforcement material that can work to improve the fracture toughness of the solid-state electrolyte layer 26 without compromising its ionic conductivity, for example, as detailed in U.S. Pat. No. 10,734,673 (Filing Date: Jun. 23, 2017; Issue Date: Aug. 4, 2020; Title: “Ionically-Conductive Reinforced Glass Ceramic Separators/Solid Electrolytes”; Inventors: Thomas A. Yersak and James R. Salvador), herein incorporated by reference in its entirety.

With renewed reference to FIG. 1, as illustrated, the negative electrode 22 may be defined by a plurality of the negative solid-state electroactive particles 50. In certain instances, as illustrated, the negative electrode 22 may be a composite layer including, for example, the negative solid-state electroactive particles 50 and a second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50; and greater than or equal to about 0 wt. % to less than or equal to about 50 wt. %, and in certain aspects, optionally greater than or equal to about 5 wt. % to less than or equal to about 20 wt. %, of the second plurality of solid-state electrolyte particles 90. In each variation, the negative electrode 22 may have an average thickness greater than or equal to about 10 μm to less than or equal to about 500 μm, and in certain aspects, optionally greater than or equal to about 10 μm to less than or equal to about 100 μm.

The second plurality of solid-state electrolyte particles 90 may be the same as or different from the first plurality of solid-state electrolyte particles 30 and/or the same as or different from the third plurality of solid-state electrolyte particles 92. In certain variations, the first plurality of solid-state electrolyte particles 30 may be the same as or different from the third plurality of solid-state electrolyte particles 92.

The negative solid-state electroactive particles 50 may be formed from a lithium host material that is capable of functioning as a negative terminal of a lithium-ion battery. For example, in certain variations, the negative solid-state electroactive particles 50 may be lithium-based, for example, a lithium alloy (e.g., lithium titanate Li₄₊ₓTi₅O₁₂, where 0≤x≤3, such as Li₄Ti₅O₁₂ (LTO)). In other variations, the negative solid-state electroactive particles 50 may include, for example only, carbonaceous materials (such as, graphite, hard carbon, soft carbon, and the like) and/or metallic active materials (such as tin, aluminum, magnesium, germanium, and alloys thereof, and the like). In still other variations, the negative solid-state electroactive particles 40 may include, for example, metal oxides (such as Fe₃O₄, V₂O₅, SnO, Co₃O₄, NbOₓ, and the like) and/or metal sulfides (such as, FeS and the like). In further variations, the negative electrode 22 may include, for example, a silicon-based electroactive material (e.g., silicon containing binary and/r ternary alloys) and/or tin-containing alloys (such as Si, Li—Si, SiOₓ (where 0≤x≤2), Si—Sn, SiSnFe, SiSnAl, SiFeCo, SnO₂, and the like).

In still further variations, the negative electrode 22 may include a combination of negative electroactive materials. For example, the negative electrode 22 may include a combination of the silicon-based electroactive material (i.e., first negative electroactive material) and one or more other negative electroactive materials. The one or more other negative electroactive materials may include, for example only, carbonaceous materials (such as, graphite, hard carbon, soft carbon, and the like) and/or metallic active materials (such as tin, aluminum, magnesium, germanium, and alloys thereof, and the like). Further still, although not illustrated, the skilled artisan will recognize that, in certain variations, the negative solid-state electroactive particles 50 (and also the optional second plurality of solid-state electrolyte particles 90) may be replaced with a lithium metal foil having, for example, an average thickness greater than or equal to about 0 nm to less than or equal to about 500 μm, and in certain aspects, optionally greater than or equal to about 50 nm to less than or equal to about 50 μm

It should also be recognized, although not illustrated, that in certain variations, the negative solid-state electroactive material particles 50 (and the optional second plurality of solid-state electrolyte particles 90) may be intermingled (e.g., slurry casted) with an electronically conductive material that provide an electron conductive path and/or a polymeric binder material that improves the structural integrity of the negative electrode 22. For example, the negative electrode 22 may include greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like. The polymeric binder in the negative electrode may be the same as or different from the polymeric binder in the solid-state electrolyte layer 26

As illustrated, the positive electrode 24 may be defined by a plurality of positive solid-state electroactive particles 60. In certain instances, as illustrated, the positive electrode may be a composite layer including, for example, the positive solid-state electroactive particles 60 and a third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60; and greater than or equal to about 0 wt. % to less than or equal to about 50 wt. %, and in certain aspects, optionally greater than or equal to about 5 wt. % to less than or equal to about 20 wt. %, of the third plurality of solid-state electrolyte particles 92.

The positive solid-state electroactive particles 60 may include nickel-rich electroactive materials (e.g., greater than or equal to about 0.6 mole fraction on transition metal lattice), such as NMC (LiNi_{1-x-y}CoₓMn_{y}O₂) (where 0.10≤x≤0.33, 0.10≤y≤0.33) or NCMA (LiNi_{1-x-y-z}CoₓMn_{y}Al_{z}O₂) (where 0.02≤x≤0.20, 0.01≤y≤0.12, 0.01≤z≤0.08). In other variations, the positive solid-state electroactive particles 60 may include one or more positive electroactive materials having a spinel structure (such as, lithium manganese oxide (Li₍₁₊ₓ₎Mn₂O₄, where 0.1≤x≤1) (LMO) and/or lithium manganese nickel oxide (LiMn₍₂₋ₓ₎NiₓO₄, where 0≤x≤0.5) (LNMO) (e.g., LiMn_{1.5}Ni_{0.5}O₄)); one or more materials with a layered structure (such as, lithium cobalt oxide (LiCoO₂) (LCO)); and/or a lithium iron polyanion oxide with olivine structure (such as, lithium iron phosphate (LiFePO₄) (LFP), lithium manganese-iron phosphate (LiMn₂₋ₓFeₓPO₄, where 0<x<0.3) (LFMP), and/or lithium iron fluorophosphate (Li₂FePO₄F)). In still other variations, the positive solid-state electroactive particles 60 may include one or more positive electroactive materials selected from the group consisting of: LFP, LNMO, LMFP, LCO, FeS₂, Li₂S, TiS₂, and combinations thereof. In further variations, the positive solid-state electroactive 60 may include a combination of any of the above listed materials positive solid-state electroactive materials.

The third plurality of solid-state electrolyte particles 92 may include one or more solid-state electrolyte materials represented by Li₃AB₆, where A is yttrium (Y), indium (In), scandium (Sc), or erbium (Er), and B is chloride (Cl), bromide (Br), and/or ClₓBr₍ₓ₋₁₎, where 0<x<1. Such solid-state electrolyte materials are thermally stable (e.g., the material does not decompose into other compounds and/or react to form a passivating layer that prevents further reaction) when used in combination with nickel-rich electroactive materials at high or elevated temperatures (e.g., above about 100° C.), as compared to sulfide electrolyte material which often react with nickel-rich electroactive materials at high temperature because of the nickel-rich electroactive materials potential to oxidize the sulfide electrolyte in physical contact, especially at high charging potentials. In the current instance, because positive solid-state electroactive particles 60 and third plurality of solid-state electrolyte particles 92 are thermally stable, the positive electrode 24 may be formed, for example as further detailed below, using a hot press process, such that the positive electrode 24 has an interparticle porosity less than or equal to about 20 vol. %, and in certain aspects, optionally less than or equal to about 15 vol. %, and an average thickness greater than or equal to about 10 μm to less than or equal to about 500 μm, and in certain aspects, optionally greater than or equal to about 10 μm to less than or equal to about 100 μm. Because of the hot press process, the positive electrode 24 may have improved active material loading. For example, the positive electrode 24 may have a cathode active material (CAM) loading greater than or equal to about 70 wt. %, optionally greater than or equal to about 80 wt. %, and in certain aspects, optionally greater than or equal to about 90 wt. %.

Although not illustrated it should be recognized that, in certain variations, the positive solid-state electroactive material particles 60 and the third plurality of solid-state electrolyte particles 92 may be intermingled (e.g., slurry casted) with an electronically conductive material that provide an electron conductive path and/or a polymeric binder material that improves the structural integrity of the positive electrode 24. For example, the positive electrode 24 may include greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or polymeric binder as included in the positive electrode 24 may be the same as or different from the conductive additive and/or polymeric binder as included in the negative electrode 22.

In various aspects, the present disclosure provides methods for preparing positive electrodes, like the positive electrode 24 illustrated in FIG. 1. For example, in certain variations, the positive electrode 24 may be prepared using a roll-to-roll hot calendaring method.

In various aspects, the present disclosure provides methods for preparing solid-state electrolyte layers, like the solid-state electrolyte layer 26 illustrated in FIG. 1. For example, in certain variations, the solid-state electrolyte layer 26 may be prepared using a hot press process that includes a roll-to-roll hot calendared method.

In certain variations, the positive electrode 24 and/or the solid-state electrolyte layer 26 may be prepared using methods like those detailed in U.S. Pat. No. 10,680,281 (Filed Date: Apr. 6, 2017; Issue Date: Jun. 9, 2020; Title “Sulfide and Oxy-Sulfide Glass and Glass-Ceramic Films for Batteries Incorporating Metallic Anodes”; Inventors: Thomas A. Yersak, James R. Salvador, Han Nguyen), herein incorporated by reference in its entirety.

In various aspects, the present disclosure provides methods for preparing an all-solid-state battery, like the battery 20 illustrated in FIG. 1. For example, in certain variations, the positive electrode 24 and solid-state electrolyte layer 26 may be prepared together using a hot press process. The combination may be subsequently stacked with a negative electrode 22 (e.g., lithium metal foil) to form the battery 20.

Certain features of the current technology are further illustrated in the following non-limiting examples.

### Example 1

Example materials may be prepared in accordance with various aspects of the present disclosure. For example, an example solid-state electrolyte layer 210 may include Li₃YCl₆ and about 3 wt. % of Kevlar® fibers. The example solid-state electrolyte layer 210 may be prepared using a hot press process, such as detailed above. In certain variations, the hot press process may include applying a temperature greater than or equal to about 200° C. to less than or equal to about 250° C., and a pressure greater than or equal to about 75 MPa to less than or equal to about 450 MPa, for a period greater than or equal to about 0.1 minute to less than or equal to about 10 minutes. By way of comparison only, a comparative solid-state electrolyte layer 220 also including Li₃YCl₆ and about 3 wt. % of Kevlar® fibers may be prepared using a cold press process, where temperatures are greater than or equal to about 10° C. to less than or equal to about 40° C.

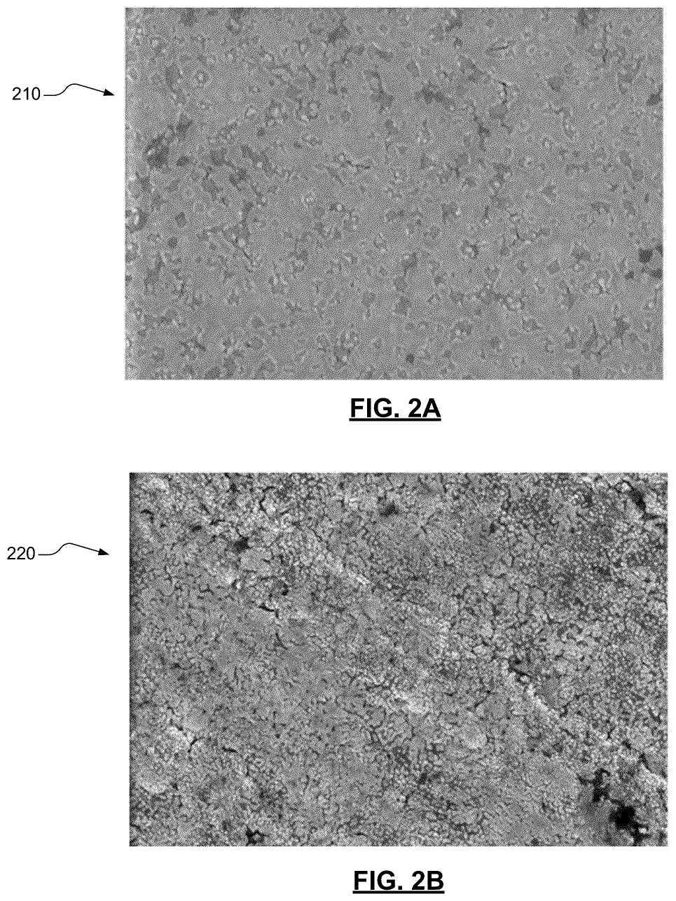

FIG. 2A is a scanning microscopy image of the example solid-state electrolyte layer 210, and FIG. 2B is a scanning microscopy image of the comparative solid-state electrolyte layer 220. The following table compares the properties of the example solids-state electrolyte layer prepared using a hot press process and the comparative solid-state electrolyte layer prepared using a cold-press process.

| | Absolute | Bulk | | Ionic |
|---|---|---|---|---|
| | Density | Density | Porosity | Conductivity |
| | (g/cm³) | (g/cm³) | (vol. %) | (mS/cm) |
| Cold Pressed Li₃YCl₆ | 2.5185 | 1.84 | 26.9 | 0.133 |
| Hot Pressed Li₃YCl₆ | 2.5185 | 2.19 | 13.1 | 0.123 |

As illustrated, the hot-pressed Li₃YCl₆ has reduced porosity, as well as improved bulk density. The slight reduction in the ionic conductivity for the hot pressed solid-state electrolyte layer 210 is not problematic because the reduction is within error of measurement.

### Example 2

Example materials may be prepared in accordance with various aspects of the present disclosure. For example, an example positive electrode 310 may include about 70 wt. % of NCM622, about 2 wt. % of carbon black, and about 30 wt. % of Li₃YCl₆. The example positive electrode 310 may be prepared using a hot press process, such as detailed above. In certain variations, the hot press process may include applying a temperature greater than or equal to about 200° C. to less than or equal to about 250° C., and a pressure greater than or equal to about 75 MPa to less than or equal to about 450 MPa, for a period greater than or equal to about 0.1 minute to less than or equal to about 10 minutes. By way of comparison only, a comparative positive electrode 320 also including about 70 wt. % of NCM622, about 2 wt. % of carbon black, and about 30 wt. % of Li₃YCl₆ may be prepared using a cold press process, where temperatures are greater than or equal to about 20° C. to less than or equal to about 40° C.

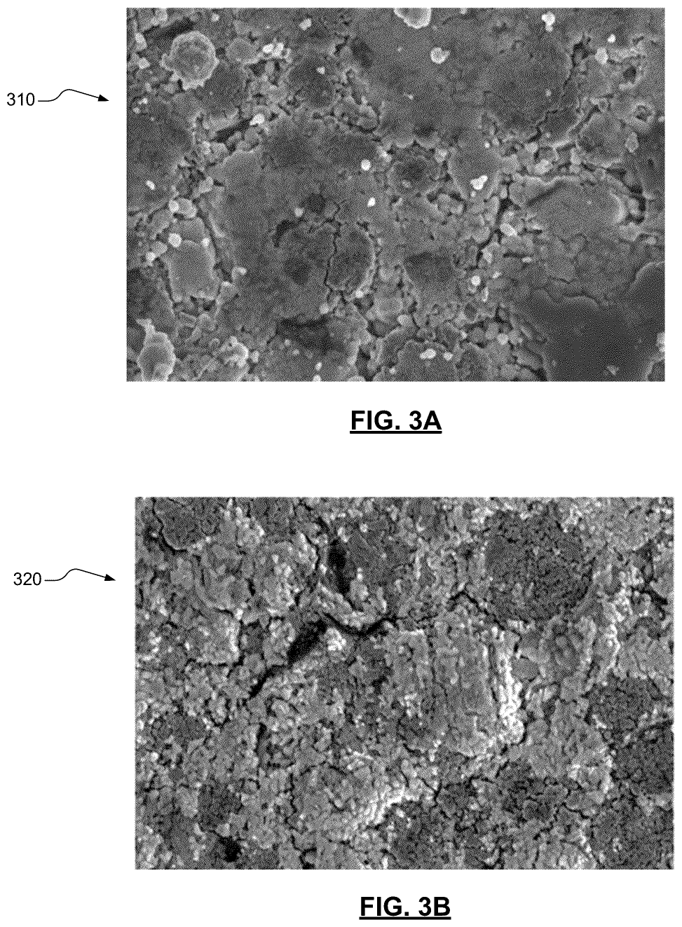

FIG. 3A is a scanning microscopy image of the example positive electrode 310, and FIG. 2B is a scanning microscopy image of the comparative positive electrode 320. The following table compares the properties of the example solids-state electrolyte layer prepared using a hot press process and the comparative solid-state electrolyte layer prepared using a cold-press process.

| | Absolute | | |
|---|---|---|---|
| | Density | Bulk Density | Porosity |
| | (g/cm³) | (g/cm³) | (vol. %) |
| Cold Pressed Cathode | 3.9484 | 3.31 | 16.2 |
| Hot Pressed Cathode | 3.9484 | 3.49 | 11.7 |

As illustrated, the example positive electrode 310 including Li₃YCl₆ and prepared using the hot press process has reduced porosity, as well as improved bulk density.

### Example 3

Example batteries and battery cells may be prepared in accordance with various aspects of the present disclosure. For example, an example battery cell 410 may include a composite cathode that comprises about 70 wt. % of NCM622, about 2 wt. % of carbon black, and about 30 wt. % of Li₃YCl₆. The example battery cell 410 may also include an indium foil anode and a solid-state electrolyte layer that separates the composite cathode and the indium foil anode. The solid-state electrolyte may include Li₃YCl₆ and about 3 wt. % of Kevlar® fibers. Like the composite cathode, the solid-state electrolyte may be prepared using a hot press process, such as detailed above. In certain variations, the hot press processes may include applying a temperature of about 200° C., and a pressure greater than or equal to about 75 MPa to less than or equal to about 450 MPa, for a period greater than or equal to about 1 minute to less than or equal to about 10 minutes. By way of comparison only, a comparison battery cell 420 may also include a composite cathode that comprises about 70 wt. % of NCM622, about 2 wt. % of carbon black, and about 30 wt. % of Li₃YCl₆. The comparison battery cell 420 may also include an indium foil anode and a solid-state electrolyte layer that separates the composite cathode and the indium foil anode. In this instance, however, the composite cathode and the solid-state electrolyte may be prepared using a cold press process, where temperatures are greater than or equal to about 10° C. to less than or equal to about 40° C.

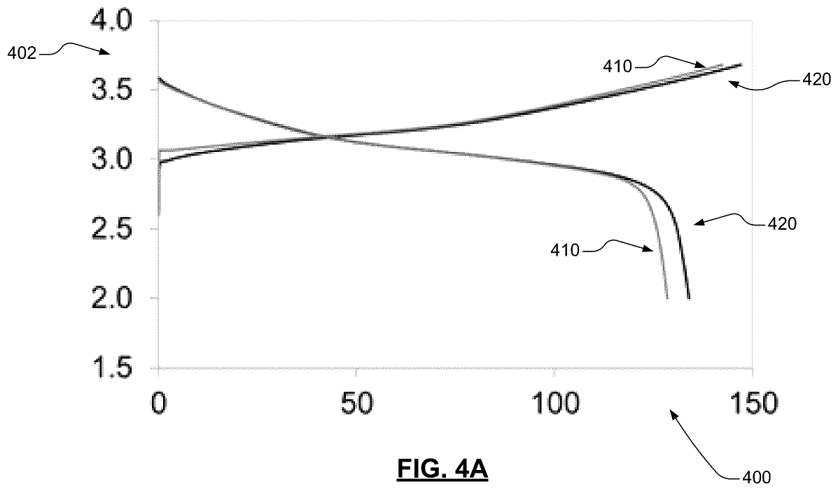

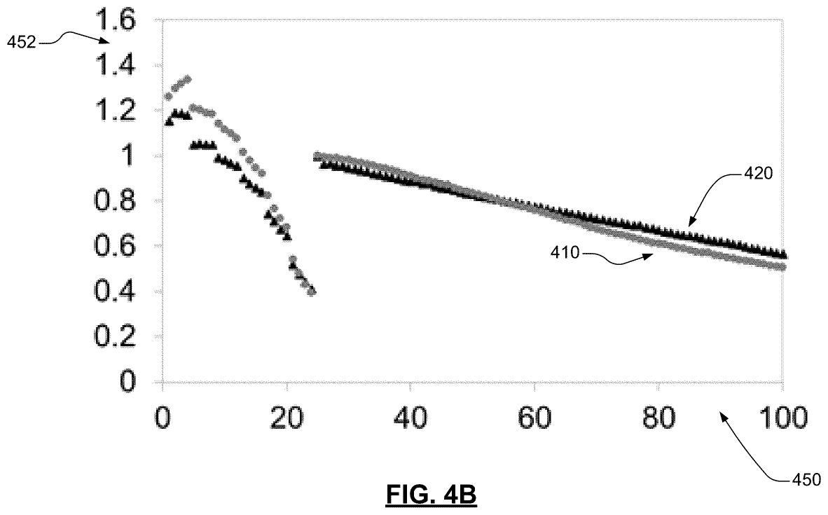

FIG. 4A is a graphical illustration for the voltage versus specific capacity of the first charge and discharge curves comparing the example battery cell 410 to the comparison battery cell 420, where the x-axis 400 represents specific capacity (mAh/g) of the cathode active materials, and the y-axis 402 represents voltage (V). As illustrated, the specific capacity of the hot pressed cell 410 is similar to that of the cold pressed cell 420, which indicates that the catholyte is adequately stable versus the cathode active material during the hot pressing.

FIG. 4B is a graphical illustration comparing the normalized capacity versus number of cycles at different C-rates of the example battery cell 410 as compared to the comparison battery cell 420, where the x-axis 450 represents cycle number, and the y-axis 452 represents the cell capacity normalized to the capacity of the first C/10 discharge cycle after a rate test. As illustrate, the hot pressed cell 410 maintains a similar normalized capacity throughout the overall battery cycle life.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An all-solid-state electrochemical battery comprising:
a positive electrode comprising a positive electroactive material and a solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof;
a negative electrode comprising a negative electroactive material; and
a solid-state electrolyte layer disposed between and separating the positive electrode and the negative electrode.

2. The all-solid-state electrochemical battery of claim 1, wherein the positive electrode has a porosity less than or equal to about 15 vol. %.

3. The all-solid-state electrochemical battery of claim 2, wherein the positive electroactive material is selected from the group consisting of: NMC (LiNi_{1-x-y}CoₓMn_{y}O₂) (where 0.10≤x≤0.33, 0.10≤y≤0.33), NCMA (LiNi_{1-x-y-z}CoₓMn_{y}Al_{z}O₂) (where 0.02≤x≤0.20, 0.01≤y≤0.12, 0.01≤z≤0.08), and combinations thereof.

4. The all-solid-state electrochemical battery of claim 2, wherein the solid-state electrolyte layer comprises a solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

5. The all-solid-state electrochemical battery of claim 1, wherein the positive electrode has a positive electroactive material loading greater than or equal to about 70 wt. %,

6. The all-solid-state electrochemical battery of claim 1, wherein the solid-state electrolyte layer has a porosity less than or equal to about 15 vol. %, and the solid-state electrolyte layer also comprises the solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof.

7. The all-solid-state electrochemical battery of claim 6, wherein the solid-state electrolyte layer further comprises a second solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

8. The all-solid-state electrochemical battery of claim 1, wherein the negative electrode comprises a lithium metal foil.

9. The all-solid-state electrochemical battery of claim 1, wherein the negative electrode comprises a negative electroactive material selected from the group consisting of: lithium, silicon, silicon oxide, graphite, Li₄₊ₓTi₅O₁₂ (where 0≤x≤3), and combinations thereof.

10. An all-solid-state electrochemical battery comprising:
a positive electrode comprising a positive electroactive material;
a negative electrode comprising a negative electroactive material; and
a solid-state electrolyte layer disposed between and separating the positive electrode and the negative electrode, the solid-state electrolyte layer comprising a solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof.

11. The all-solid-state electrochemical battery of claim 8, wherein the solid-state electrolyte layer has a porosity less than or equal to about 15 vol. %.

10. The all-solid-state electrochemical battery of claim 8, wherein the positive electroactive material is selected from the group consisting of: NMC (LiNi_{1-x-y}CoₓMn_{y}O₂) (where 0.10≤x≤0.33, 0.10≤y≤0.33), NCMA (LiNi_{1-x-y-z}CoₓMn_{y}Al_{z}O₂) (where 0.02≤x≤0.20, 0.01≤y≤0.12, 0.01≤z≤0.08), and combinations thereof.

11. The all-solid-state electrochemical battery of claim 8, wherein the positive electrode also comprises the solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof.

12. The all-solid-state electrochemical battery of claim 8, wherein the solid-state electrolyte material is a first solid-state electrolyte material and the solid-state electrolyte layer further comprises a second solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.

13. The all-solid-state electrochemical battery of claim 11, wherein the positive electrode has a porosity less than or equal to about 15 vol. %.

14. A method for preparing an all-solid-state battery, the method comprising:
preparing a positive electrode having a porosity less than or equal to about 15 vol. % and a positive solid-state electroactive material loading greater than or equal to about 70 wt. % by
contacting a plurality of positive solid-state electroactive particles and a plurality of solid-state electrolyte particles to form an admixture, the solid-state electrolyte particles comprising a solid-state electrolyte material represented by Li₃AB₆, where A is selected from the group consisting of: yttrium (Y), indium (In), scandium (Sc), erbium (Er), and combinations thereof, and B is selected from the group consisting of: chloride (Cl), bromide (Br), ClₓBr₍ₓ₋₁₎ (where 0<x<1), and combinations thereof; and
applying a pressure to the admixture at a temperature greater than or equal to about 200° C. to less than or equal to about 250° C. for a period greater than or equal to about 0.1 minutes to less than or equal to about 10 minutes to form the positive electrode, the pressure being greater than or equal to about 75 MPa to less than or equal to about 450 MPa.

15. The method of claim 14, wherein the plurality of solid-state electrolyte particles is a first plurality of solid-state electrolyte particle, the pressure is a first pressure, the temperature is a first temperature, and the period is a first period, and the method further comprises:
preparing a solid-state electrolyte layer by applying a second pressure to a second plurality of solid-state electrolyte particles at a second temperature greater than or equal to about 200° C. to less than or equal to about 250° C. for a second period greater than or equal to about 0.1 minute to less than or equal to about 10 minutes to form the solid-state electrolyte layer, the second pressure being greater than or equal to about 75 MPa to less than or equal to about 450 MPa, and the preparing of the solid-state electrolyte layer occurs concurrently or consecutively with the preparing of the positive electrode.

16. The method of claim 15, wherein the solid-state electrolyte layer is prepared concurrently with the positive electrode, and the method further comprises, disposing the second plurality of solid-state electrolyte particles adjacent to the admixture.

17. The method of claim 16, wherein the method further comprises disposing a lithium metal foil on or adjacent to an exposed surface of the solid-state electrolyte layer.

18. The method of claim 16, wherein the admixture is a first admixture and the method further comprises disposing a second admixture on or adjacent to an exposed surface defined by the second plurality of solid-state electrolyte particles, the second admixture comprising a plurality of negative solid-state electroactive particles and a third plurality of solid-state electrolyte particle.

19. The method of claim 15, wherein the second plurality of solid-state electrolyte particles is the same as the first plurality of solid-state electrolyte particles.

20. The method of claim 15, wherein the solid-state electrolyte material is a first solid-state electrolyte material and the second plurality of solid-state electrolyte particles comprise a second solid-state electrolyte material selected form the group consisting of: sulfide-based solid-state electrolyte material, halide-doped sulfide-based solid-state electrolyte material, oxysulfide solid-state electrolyte material, halide-doped oxysulfide solid-state electrolyte material, and combinations thereof.
